(19) United States
(12) Patent Application Publication
(10) Pub. No.: US 2006/0233939 A1
(43) Pub. Date: Oct. 19, 2006

(54) Method of preparing moulded confectionery articles

(76) Inventors: Nigel Hugh Sanders, Ontario (CA); Ian Humphrey Smith, Berkshire (GB); Anthony James Brown, Berkshire (GB); Benoit Minville, Quebec (CA)

Correspondence Address: HOFFMANN & BARON, LLP, 6900 JERICHO TURNPIKE, SYOSSET, NY, 11791, US

(21) Appl. No.: 10/533,101

(22) PCT Filed: Oct. 28, 2003
(86) PCT No.: PCT/GB03/04624

§ 371 Date: Mar. 20, 2006

(30) Foreign Application Priority Data
Oct. 29, 2002 (GB) 0225087.6

(51) Int. Cl. A23G 3/00

(52) U.S. Cl. 426/660

(57) ABSTRACT

The present invention discloses a method of preparing moulded confectionery articles, comprising the steps of: (1) preparing a liquid candy composition which solidifies upon cooling, said liquid candy composition being at a first temperature; (2) preparing a liquid chocolate composition which solidifies upon cooling, said liquid chocolate composition being at a second temperature which is lower than said first temperature; (3) co-depositing the liquid candy composition and the liquid chocolate compositions in the moulds; and (4) cooling the moulded compositions in the moulds so as to solidify the moulded compositions to form moulded confectionery articles; wherein the liquid chocolate composition is subjected to a high shear of at least 100 s⁻¹, before being co-deposited in the moulds. This treatment enables the candy composition to be deposited into the moulds at a temperature which is higher than has heretofore been considered possible.

This invention relates to a method of preparing moulded confectionery articles and is more concerned with a method of preparing moulded confectionery articles comprising both a candy composition and a chocolate composition.

It is known to prepare moulded confectionery articles comprising a candy outer layer with an inner core formed of chocolate. However, problems arise when moulding such confectionery articles because the candy composition needs to be deposited in the moulds at a relatively high temperature to enable the candy to flow properly. On the other hand, chocolate suffers from the disadvantage that, when it is heated above a critical temperature, it exhibits a sharp increase in viscosity making it virtually impossible to mould successfully. This critical temperature is generally in the range of about 50° C. to 120° C. but depends upon the nature of the chocolate formulation. The critical temperature is higher for dark chocolate (i.e. chocolate containing no milk solids) than for milk and white chocolate, both of which contain milk solids. This sharp increase in viscosity also occurs with chocolate compound coatings.

Furthermore, chocolate also tends to degrade when exposed for extended periods of time to temperatures rather lower than the critical temperatures. Thus, it is common to set practical upper temperature limits when handling chocolate. The limits are typically set at 85° C. for dark chocolate, and 75° C. for milk and white chocolates. Above these temperatures, the viscosity of the chocolate increases, and extended holding times causes flavour degradation, and eventually the product solidifies into an unworkable mass.

It is an object of the present invention to provide an improved method of preparing moulded confectionery articles which enables the above-mentioned problems to be mitigated.

According to the present invention, there is provided a method of preparing moulded confectionery articles, comprising the steps of:
(1) preparing a liquid candy composition which solidifies upon cooling, said liquid candy composition being at a first temperature;
(2) preparing a liquid chocolate composition which solidifies upon cooling, said liquid chocolate composition being at a second temperature which is lower than said first temperature;
(3) co-depositing the liquid candy composition and the liquid chocolate composition in moulds; and
(4) cooling the moulded compositions in the moulds so as to solidify the moulded compositions to form moulded confectionery articles;
   wherein the liquid chocolate composition is subjected to a high shear of at least 100 s⁻¹, preferably up to 5000 s⁻¹, before being co-deposited in the moulds.

By subjecting the liquid chocolate composition to a high shear before it is co-deposited into the moulds, it is found that the liquid chocolate composition can remain mouldable at temperatures above the temperature at which it normally exhibits a sharp increase in viscosity. Thus, this procedure enables the candy composition to be deposited into the moulds at a temperature which is higher than has heretofore been considered possible.

Co-depositing the candy composition and the chocolate composition in the mould ensures that the chocolate composition is exposed to the higher first temperature for only a relatively short period of time, thus reducing the risk of flavour degradation and product solidification.

For example, it is found that, even when the chocolate composition is a milk chocolate composition, it can be successfully co-deposited with a liquid candy composition at temperatures as high as 150° C. using a one-shot co-depositor, if the chocolate composition is subjected to a high shear of at least 100 s⁻¹, and preferably at about 500 s⁻¹, and preferably up to 5000 s⁻¹.

The candy composition may be any sugar-based candy composition such as a hard candy composition or a caramel composition. These are generally compositions which are produced by boiling a sugar syrup to a temperature of about 150° C. and introducing flavourings into the cooked sugar. These high boiling compositions must be deposited at at least about 135° C. to avoid so-called “tailing” during depositing. In contrast, the chocolate composition is maintained at a much lower temperature (typically about 40° C.) up until the time when it is co-deposited with the candy composition. At which time, it becomes heated to about 135° C. as a result of heat transfer from the candy composition.

In the case where the chocolate composition to be deposited has a relatively low critical temperature, in addition to subjecting it to a high shear, it is also within the scope of the invention to include a minor amount of dark chocolate (e.g. up to about 10%) so as to increase its critical temperature. However, this procedure does suffer from the disadvantage that the taste of the chocolate is changed and may also increase the cost of production.

It is further possible to improve the viscosity characteristics of the chocolate being moulded by increasing the fat content by, for example, addition of cocoa butter in an amount of at least 1% by weight and preferably at least 2% by weight.

Preferably, the chocolate is subjected to a high shear in the range of 100 to 1000 s⁻¹, more preferably 200 to 500 s⁻¹ before being deposited into the moulds.

The chocolate composition may be subjected to high shear either in the depositor itself immediately prior to being introduced into the moulds, or it may be subjected to high shear prior to being passed to the depositor. However, it is important to effect such shearing at a stage when the chocolate will not lose its advantageous viscosity characteristics before being deposited into the moulds.

In one series of embodiments, the chocolate composition is subjected to high shear prior to being passed into the depositor and in the depositor itself, the first shearing process being referred to hereinafter as “pre-shear”. Preferably, said pre-shear is from about 100 s⁻¹ to 5000 s⁻¹. More preferably, the chocolate composition is subjected to a pre-shear which is greater than the subsequent shear in the depositor.

An example of the present invention will now be described in more detail.

Recipe

| | Ingredient | % by weight |
|---|---|---|
| 1) | Premix of | |
| | Liquid sugar | 54.3 |
| | Glucose Syrup | 35.5 |
| 2) | Flavour | 0.2 |
| 3) | Milk Chocolate coating (see Example below) | 10.0 |

Process
1. The pre-mix was batch weighed into a heated tank.
2. The pre-mix was transferred via a small buffer tank to a pre-cooker and heated to 126° C.
3. The pre-mix was then transferred to a Microfilm vacuum cooker where it was cooked at 150° C. in a vacuum of 3 inHg (10.2 kPa).
4. The flavour was mixed into the cooked candy mass which was then transferred to the depositor hopper (temperature 140° C.).
5. Molten chocolate coating at 40° C. was pumped to the depositor hopper (temperature 50° C.).
6. The cooked candy mass and the chocolate were co-deposited through a manifold plate at 135° C. into moulds, at a speed of 70 strokes per minute (Baker Perkins (APV) model 156 depositer 156/049).
7. The moulds were immediately transferred into a cooling tunnel set to 25° C. and 35% RH (relative humidity) to harden and cool down the candy
8. The candies were then de-moulded and fed automatically via conveyors to wrapping machines.

The average shear rate experienced by the chocolate in the narrowest section of the depositor (i.e. the depositor nozzle) was calculated to be 245 s⁻¹ (i.e. half the shear rate experienced at the wall of the depositor nozzle, assuming Newtonian flow behaviour).

| Example Milk chocolate coating composition | % by weight |
|---|---|
| Milk chocolate crumb | 69.8 |
| Cocoa butter equivalent | 21.9 |
| Butter oil | 0.3 |
| Soya lecithin | 0.3 |
| Sugar | 4.2 |
| Cocoa liquor | 3.4 |
| Flavour | 0.1 |

In a modification of the above Example, the molten chocolate composition is subjected to a pre-shear in an in-line shear mixer prior to being pumped into the depositor.

1. A method of preparing moulded confectionery articles, comprising the steps of:
(1) preparing a liquid candy composition which solidifies upon cooling, said liquid candy composition being a first temperature;
(2) preparing a liquid chocolate composition which solidifies upon cooling, said liquid chocolate composition being at a second temperature which is lower than said first temperature;
(3) co-depositing the liquid candy composition and the liquid chocolate composition in moulds; and
(4) cooling the moulded compositions in the moulds so as to solidify the moulded compositions to form moulded confectionery articles;
wherein the liquid chocolate composition is subjected to a high shear of at least 100 s⁻¹, before being co-deposited in the moulds.

2. The method of claim 1, wherein the liquid chocolate composition is subjected to a shear of from 100 to 1000 s⁻¹.

3. The method of claim 1, wherein the liquid chocolate composition is subjected to a shear of from 200 to 500 s⁻¹.

4. The method of claim 1, wherein the candy composition is a hardy candy or caramel composition and the first temperature is from 135° C. up to 150° C.

5. The method of claim 1, wherein the second temperature is about 40° C.

6. The method of claim 1, wherein the chocolate composition is a milk chocolate composition.

7. The method of claim 6, wherein up to 10% dark chocolate is added to the milk chocolate composition prior to step (3).

8. The method of claim 1, wherein additional fat is added to the chocolate composition so as to increase its fat content by at least 1% by weight, prior to step (3).

9. The method of claim 1, wherein the chocolate composition is subjected to the high shear in the depositor immediately prior to being introduced into the moulds during step (3).

10. The method of claim 1, wherein the chocolate composition is subjected to the high shear prior to step (iii).

11. The method of claim 9, wherein the chocolate composition is subjected to a pre-shear prior to step (iii).

12. The method of claim 11, wherein the pre-shear is in the range of from 100 s⁻¹ to 5000 s⁻¹.

13. The method of claim 11, wherein the pre-shear is greater than the high shear.

14. The method of claim 12, wherein the pre-shear is greater than the high shear.
